(19) United States
(12) Patent Application Publication
(10) Pub. No.: US 2010/0209069 A1
(43) Pub. Date: Aug. 19, 2010

(54) System and Method for Pre-Engineering Video Clips

(76) Inventor: Dennis Fountaine, Sarasota, FL (US)

Correspondence Address: CARR & FERRELL LLP, 2200 GENG ROAD, PALO ALTO, CA, 94303, US

(21) Appl. No.: 12/562,970

(22) Filed: Sep. 18, 2009

Related U.S. Application Data
(60) Provisional application No. 61/192,542, filed on Sep. 18, 2008.
(60) Provisional application No. 61/192,674, filed on Sep. 18, 2008.
(60) Provisional application No. 61/192,642, filed on Sep. 18, 2008.

(51) Int. Cl. G11B 27/022

(52) U.S. Cl. 386/52; 386/E05.003

(57) ABSTRACT

Methods and systems for pre-engineering video clips for use in an interactive entertainment system are provided. An engineer designates a video clip for pre-engineering and provides information regarding the video clip. The presence of a performer is detected in the video clip, and the face of the performer is defined. A portion of the video clip corresponding to the face of the performer is designated for masking. The masking designation may then be stored in memory in association with information provided by the engineer.

### CROSS-REFERENCE TO RELATED APPLICATIONS

The present application claims the priority benefit of U.S. provisional patent application No. 61/192,642 filed Sep. 18, 2008 and entitled “Interactive Entertainment System, U.S. provisional patent application No. 61/192,542 filed Sep. 18, 2008 and entitled “System and Method for Pre-Engineering Video Clips,” and U.S. provisional patent application 61/192,674 filed Sep. 18, 2008 and titled “System and Method for Social Casting Call,” the disclosures of the aforementioned applications being incorporated herein by reference.

### BACKGROUND OF THE INVENTION

1. Field of the Invention

The present invention generally relates to video clips. More specifically, the present invention concerns pre-engineering video clips.

2. Description of Related Art

Presently, video clips can originate from movies, television shows, radio shows, music videos, cartoons, video games, advertisements, commercials, news shows, or other sources. In addition to full-length television programs and movies made freely available on-line by well-established television networks and media sources, Internet users can also access, view, upload, share, and/or critique millions of video clips, including amateur video clips made available on websites such as YouTube or iPlayer.

Video and audio are media that allow individuals to showcase their performances for various audiences. Such performances may include singing, dancing, acting, orating, debating, animation, etc. Showcasing one's performance is particularly important in the fields of musical, theatrical, and cinematic arts. Singers, dancers, and actors of all types need to be able to demonstrate their singing, dancing, or acting abilities in order to obtain employment in their chosen fields. Such a demonstration may occur in the context of an audition or audio-video recordings of a past performance.

In a general casting call, for example, a casting director or associate generally manages a process to select one or more actors or other entertainment performers to fulfill one or more roles in a live or recorded performance. The casting process is typically performed live and can be burdensome, time-consuming and stressful for all parties involved. Such live auditions may be restricted in terms of geography, timing, scheduling, etc. For example, an audition may be held in an inconvenient location, at an inconvenient time, and/or may not allow much time for a full performance. Further, an audition may lack the context of an actual performance (e.g., band, orchestra, costuming, lighting, sets, other performers).

While an audio-video recording may provide such context, some individuals may not have the resources or the opportunity to prepare such a recording or the opportunity. There is therefore, a need for an interactive entertainment system for recording performances and pre-engineering video clips for use in such an interactive entertainment system.

### SUMMARY OF THE INVENTION

Embodiments of the present invention provide for methods and systems for pre-engineering video clips. An engineer designates a video clip for pre-engineering and provides information regarding the video clip. The presence of a performer is detected in the video clip, and the face of the performer is defined. A portion of the video clip corresponding to the face of the performer is designated for masking. The masking designation may then be stored in memory in association with information provided by the engineer. Such a masking designation indicates what portion of the video clip may be replaced with a corresponding portion of a user recording. For example, the face of a performer may be replaced in a modified video clip with a face of a user, such that the user appears to be performing in the modified video clip.

Methods for pre-engineering video clips may include receiving information from an engineer regarding a video clip, detecting that a performer is present in the video clip, defining a face associated with the performer detected as being present in the video clip, and designating a portion of the video clip for masking, the designated portion of the video clip corresponding to the defined face associated with the performer. Such methods may further include storing the masking designation in memory in association with the information received from the engineer. Various embodiments may also provide for use of facial recognition technology and definition of a body of the performer, such that the masking designation may further correspond to the body of the performer.

Some embodiments of the present include systems for pre-engineering video clips. Such systems may include an interface configured to receive information from an engineer regarding a video clip and a processor configured to execute instructions for detecting that a performer is present in the video clip, for defining a face associated with the performer detected as being present in the video clip, and designating a portion of the video clip for masking, the designated portion of the video clip corresponding to the defined face associated with the detected performer. Systems may further include a memory for storing the masking designation in memory, the masking designation being stored in association with the information received from the engineer.

Embodiments further provide for computer-readable storage media having embodied thereon programs for performing methods for pre-engineering video clips.

### BRIEF DESCRIPTION OF THE DRAWINGS

FIG. 1 is a diagram of an environment in which embodiments of the present invention may be practiced.

FIG. 2 is a flowchart of an exemplary method for pre-engineering video clips.

FIG. 3A is a screenshot of an exemplary implementation of a system for pre-engineering video clips.

FIG. 3B is a screenshot of a pre-engineered video clip as it may be used in an exemplary implementation of an interactive entertainment system for recording performance.

FIG. 4 is a screenshot of an exemplary interface for pre-engineering video clips.

FIG. 5 is a screenshot of an exemplary interface for establishing pre-engineered video clips.

FIG. 6 is a screenshot of an exemplary interface of an interface for detecting a user's image.

FIG. 7 is a screenshot of an exemplary pre-engineered video clip incorporating lines from an associated script.

### DETAILED DESCRIPTION

Embodiments of the present invention provide systems and methods for pre-engineering video clips to be used in an interactive entertainment system. In exemplary embodiments, a user may place themselves and/or others into a video clip by using the pre-engineered video clip for guidance. The video clip may comprise, for example, a scene from a movie, television show, music video, cartoon, video game, or commercial. Other types of video clips may be utilized as well. As a result, a modified video clip may be generated whereby the user becomes the “actor” in the video clip. Before being accessed by the user, however, the clips may be pre-engineered to designate which portions of the video clip may be replaced (e.g., face and/or body), as well as generate and store information regarding the video clip.

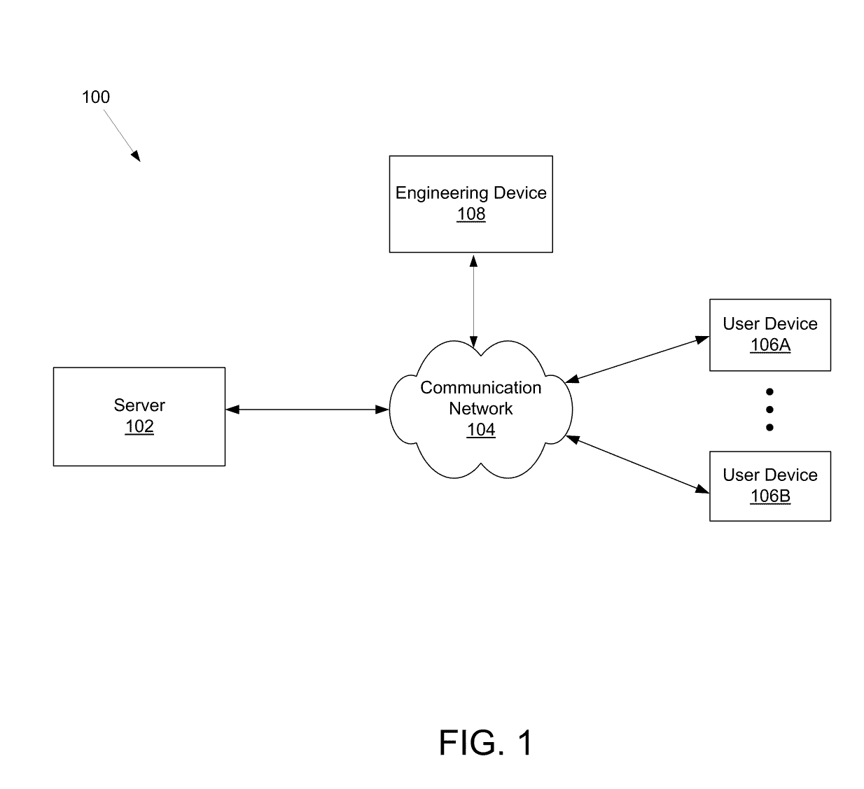

FIG. 1 illustrates an exemplary environment 100 in which embodiments of the present invention may be implemented. In exemplary embodiments, a server 102 is coupled via communication network 104 to a plurality of user devices 106A-106B and an optional engineering device 108. The communication network 104 may comprise the Internet, wide area network, and/or a local area network. Certain security protocols (e.g., SSL or VPN) or encryption methodologies may be used to ensure security of data exchanges over communication network 104.

In exemplary embodiments, the server 102 is configured to store and provide pre-engineered video clips for use in generating the interactive video clip. In some embodiments, some of the functionalities of the server 102 may occur at other devices coupled to the server 102. For example, an separate engineering device 108 may be used to pre-engineer the video clips, which are then uploaded onto the server 102. For simplicity, embodiments of the present invention will be discussed wherein the engineering device 108 is configured to perform the pre-engineering of video clips. However, it is contemplated that other devices, such as the server 102, may perform some or all of the pre-engineering functions.

The user devices 106 may be associated with one or more users interested in generating a video clip using the interactive entertainment system of the present invention. The user devices 106 may include any type of device that has access to the communication network 104. For example, the user devices 106 may comprise a computing device, a laptop or desktop computer, a cellular telephone, a personal digital assistant (PDA), MP3 player, or any other computing or digital device.

It should be noted that FIG. 1 illustrates one exemplary embodiment of the environment 100. Alternative embodiments may comprise any number of user devices 106 coupled to any type of communications network 104. Additionally, more than one server 102 may be present.

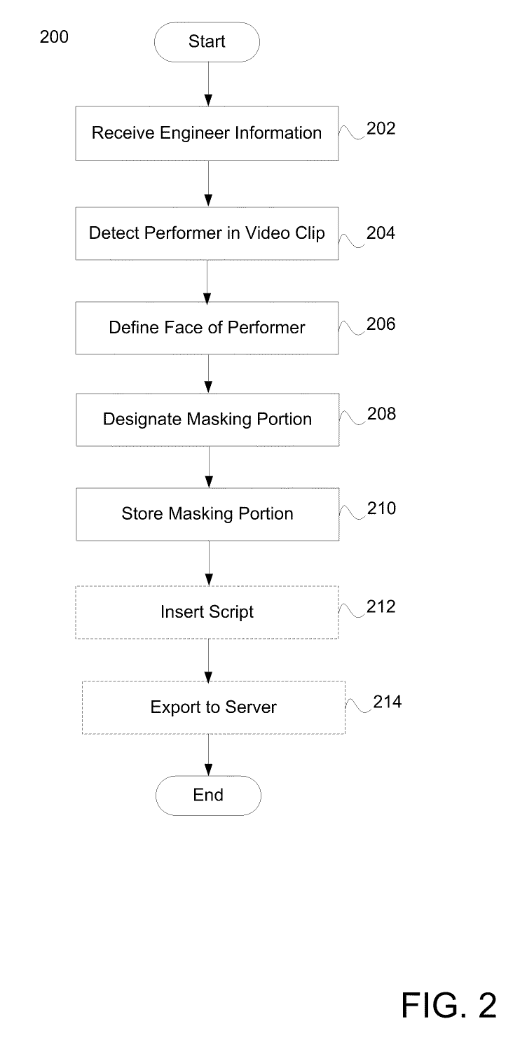

FIG. 2 is a flowchart of an exemplary method 200 for pre-engineering video clips. In the method, engineer information regarding a video clip is received, a performer is detected in the video clip, a face of the performer is defined, and a masking portion corresponding to the face of the performer is designated. Optionally, portions of the script may be inserted for display in the video clip, which may then be exported to server 102.

In step 202, engineer information regarding the video clip is received. In an exemplary implementation, the engineer may upload or designate a video clip for engineering and provide information regarding the video clip. For example, the video clip may comprise a scene from a movie. As such, the movie is received from a movie studio and the scene is edited out from the movie to generate the video clip. The information from the engineer may include indications regarding the name of the movie, year, actors, description of the scene, movie studio, and other information that would allow users may easier identify and review the video clips. Such information may include the length of the video clip, number of frames within the video clip, etc.

In step 204, a performer is identified as being present in the video clip. The engineering device 108 (or server 102) may automatically detect that one or more performers are present in the video. Alternatively, an engineer may indicate a number of performers, and the engineering device 108 searches the video clip for that number of performers. Another alternative is for the engineer to select the performers found in the video clip using a selection tool.

In step 206, a face of the performer is defined. The definition of a face may incorporate usage of a facial recognition tool or application. In some embodiments, an engineer may, using a selection tool, select one or more faces within the video clip which will be replaced by images of faces of user(s). The number of faces is only limited by a number of characters in the video clip. Various tools for defining the face may be employed, including, for example, an eight point spline system to define the boundaries of the face of the performer. In some embodiments, a body or part(s) of a body of the perfomer may also be defined.

In step 208, a portion of the video is designated for masking. The designated portion may correspond to the face defined in step 206. While embodiments of the present invention are discussed with respect to replacing facial images, alternative embodiments may replace other portion of the body. As such, where a body or part of a body of the performer was defined, the portion designated for masking may correspond to the defined body or defined body part. Those portions of the body may be selected in a similar manner. It should be noted that any number of faces (or bodies) of characters may be selected for masking. Masking will occur with respect to actual usage of the interactive entertainment system (i.e., when a user provides a recording of a user performance). A portion of the user recording (i.e., user face or user body) may replace, or mask, a corresponding portion designated for masking. Generation of the modified video clip incorporating user performance is discussed further in co-pending U.S. patent application ______, titled “Interactive Entertainment System for Recording Performance” and filed concurrently.

In step 210, information regarding the masking portion of video clip is stored in association with the information provided by the engineer in step 202. As such, the information may be stored together for access by various users searching for a particular video clip or type of video clip. When a video clip is provided to a user, therefore, access to the information provided by the engineer and the masking designation may also be provided along with the video clip. The information may be stored in a database hosted by server 102 or engineering device 108.

In step 212, lines from a script may be inserted into the video clip. The result is a modified video clip that allows a user to read the script lines as the lines are performed by the performers present in the video clip (e.g., like a karaoke video). The lines of the script may appear as subtitles, captions, or in some other form associated with the video clip. In some embodiments, the engineer may provide the words by typing, uploading, or designating lines from an uploaded script using the engineering device 108.

A countdown timer may also be inserted into the video clip in step 212. The countdown timer is configured to countdown to a start time for the user to start reading the words displayed in the scripted version. The countdown timer may also be used to start a web camera associated with the user device 106 which is used to capture the user's image. In one embodiment, a five second countdown may be provided from the start of a recording process to a first word of a script.

Finally, the pre-engineered video clip may be exported to another location (e.g., server 102) in step 214. In some embodiments, the engineered video clip may be exported to a clip library associated with or hosted on the server 102 or engineering device 108. Some implementations further allow for a local system (e.g., the engineering device 108) to be compared with the server 102 to determine if there is any overlap with a video clip already stored in the clip library. The engineer may receive a notification that a duplicate video clip already exists in the clip library. As a result, duplicate video clips may be deleted and/or not uploaded to the clip library. In some embodiments, duplicate detection may occur automatically. A user of an interactive system for recording performance would, therefore, submit its request to the clip library. In response, the clip library may provide access to the pre-engineered video clip for use in generating modified video clips incorporating user performances.

It should be noted that the method of FIG. 2 is exemplary. Alternative embodiments may comprise more, less, or other steps and still be within the scope of the present embodiment. Additionally steps may be practiced in a different order.

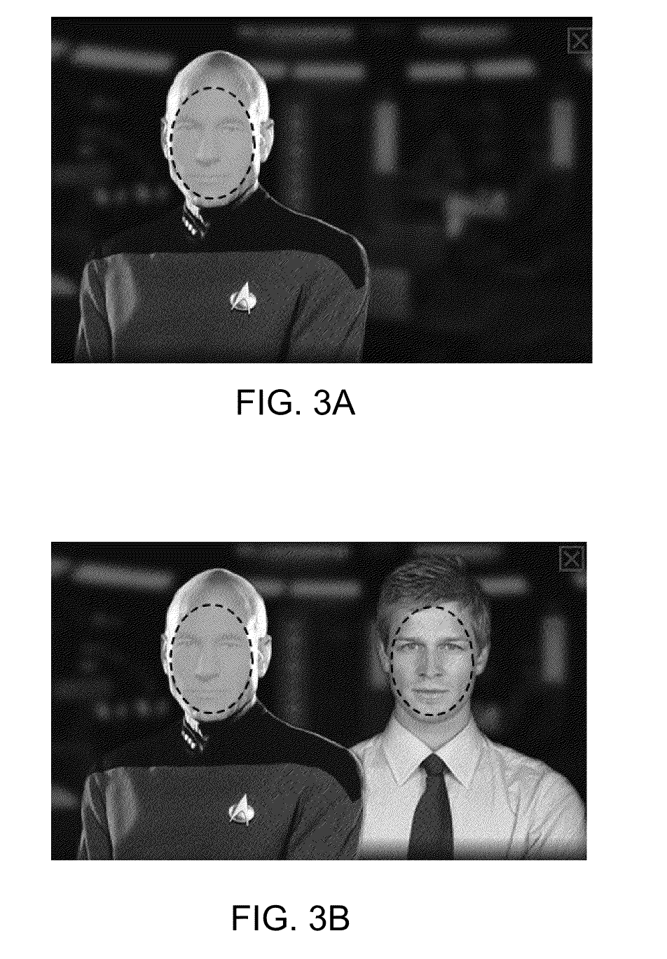

FIG. 3A is a screenshot of an exemplary implementation of a system for pre-engineering video clips. In FIG. 3A, the performer present in the video clip is illustrated with a masking designation on his face. The portion of the face to be masked is designated by the hashed line. During normal play of the video clip provided to the user, the performer may not appear masked. The information provided with video clip, however, will indicate that the face of the performer is designated for masking.

FIG. 3B is a screenshot of a pre-engineered video clip as it may be used in an exemplary implementation of an interactive entertainment system for recording performance. FIG. 3B illustrates that an image of a user is being designated for insertion into a corresponding portion of the video clip. In this instance, the face of the user is designated (e.g., by hashed lines) to replace the face of the performer present in the video clip.

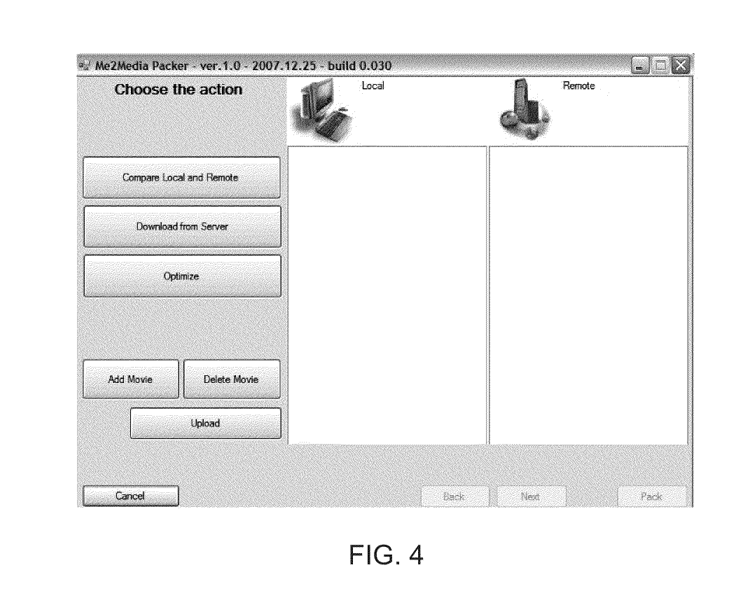

FIG. 4 is a screenshot of an example interface for pre-engineering video clips. The interface allows an engineer to download, add, and/or designate a video clip for pre-engineering.

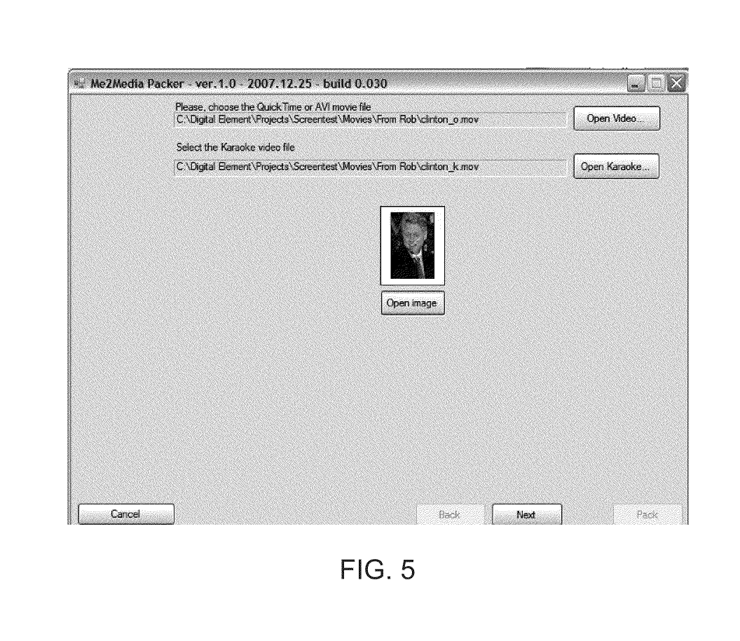

FIG. 5 is a screenshot of an exemplary interface for establishing various versions of pre-engineered video clips. Through use of such an interface, a scripted video clip and a pre-engineered but non-scripted video clip may be identified. In addition, a thumbnail representing the video clip may be added. It should be noted that the scripted video clip file (i.e., karaoke video clip) and the editable video clip may be of different lengths in some embodiments.

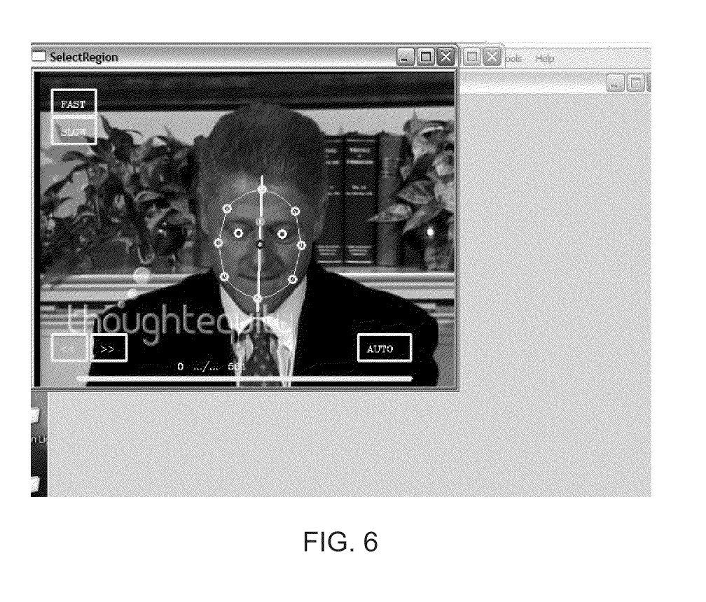

FIG. 6 is a screenshot of an exemplary interface for detecting a character's image which will be replaced. In exemplary embodiments, an eight point spline system is used to define what portions of the character's face should be masked out when the user's face is composited with the editable video clip. The system may automatically detect the correct portions to mask once selected. The face orientation may also be adjusted for the purpose of compositing and target eye positioning. This may be important, for example, when used in a cartoon video clip. The engineer may also evaluate the video clip frame by frame to make minor adjustments.

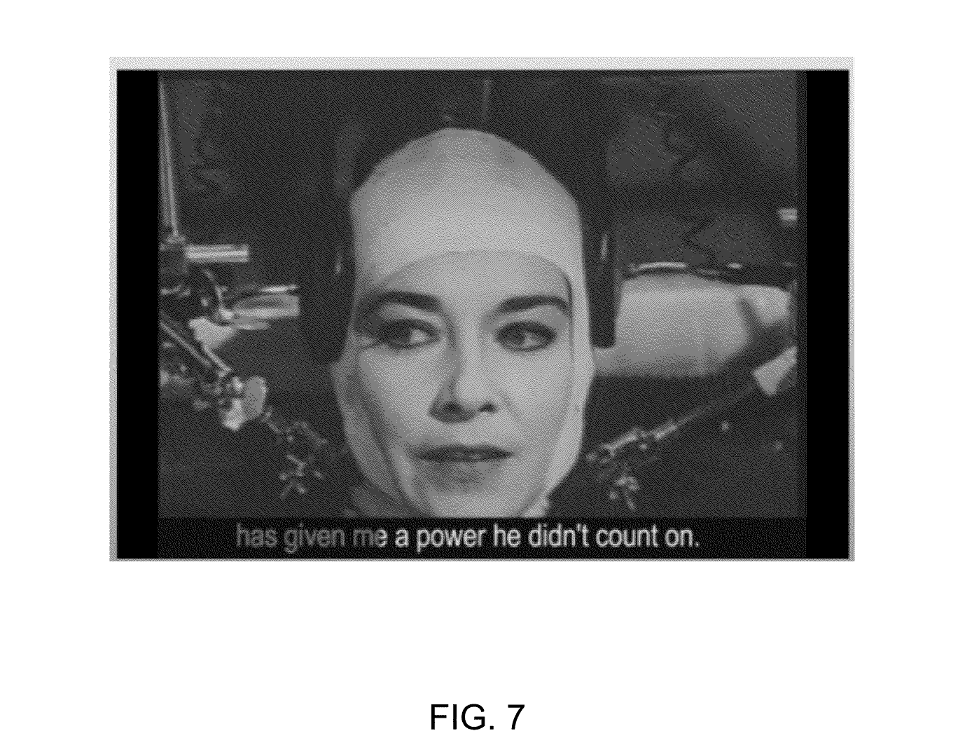

FIG. 7 is a screenshot of an exemplary pre-engineered video clip incorporating lines from an associated script. When the video clip is played, the script lines appear at intervals corresponding to the instances in the video when the lines are spoken, sung, or otherwise performed by the performer.

The present invention may be implemented in an application that may be operable using a variety of end user devices. The present methodologies described herein are fully intended to be operable on a variety of devices. The present invention may also be implemented with cross-title neutrality wherein an embodiment of the present system may be utilized across a variety of titles from various publishers.

Computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of computer-readable media include, for example, a floppy disk, a flexible disk, a hard disk, magnetic tape, any other magnetic medium, a CD-ROM disk, digital video disk (DVD), any other optical medium, RAM, PROM, EPROM, a FLASHEPROM, any other memory chip or cartridge.

Various forms of transmission media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU. Various forms of storage may likewise be implemented as well as the necessary network interfaces and network topologies to implement the same.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for pre-engineering video clips for use in an interactive entertainment system, the method comprising:
receiving information from an engineer, the information regarding a video clip;
executing instructions stored in memory, wherein execution of the instructions by a processor:
detects that a performer is present in the video clip,
defines a face associated with the performer detected as being present in the video clip, and
designates a portion of the video clip for masking, the designated portion of the video clip corresponding to the defined face associated with the performer;
and
storing the masking designation in memory, the masking designation being stored in association with the information received from the engineer.

2. The method of claim 1, wherein detection of the performer is based at least in part on the information received from the engineer.

3. The method of claim 1, further comprising defining at least a part of a body associated with the performer, wherein the designated portion of the video clip further corresponds to the defined body part associated with the performer.

4. The method of claim 1, wherein the definition of the face is based on execution of a facial recognition application.

5. The method of claim 1, wherein the definition of the face is based at least in part on an eight point spline system.

6. The method of claim 1, wherein the definition of the face is based at least in part on the information received from the engineer.

7. The method of claim 1, wherein the information received from the engineer includes a script.

8. The method of claim 7, further comprising generating a modified version of video clip, the modified video clip displaying portions of the script inserted at intervals designated by the engineer.

9. The method of claim 1, further comprising detecting that a duplicate video clip already exists in memory and generating a notification regarding the duplicate video clip.

10. The method of claim 1, further comprising indexing the information stored in memory based on information received from the engineer.

11. The method of claim 1, further comprising exporting the stored information via a communication network to a clip library.

12. A system for pre-engineering video clips for use in an interactive entertainment system, the system comprising:
an interface configured to receive information from an engineer, the information regarding a video clip;
a processor configured to execute instructions stored in memory, wherein execution of the instructions:
detects that a performer is present in the video clip,
defines a face associated with the performer detected as being present in the video clip, and
designates a portion of the video clip for masking, the designated portion of the video clip corresponding to the defined face associated with the detected performer; and
a memory configured to store the masking designation in memory, the masking designation being stored in association with the information received from the engineer.

13. The system of claim 12, further comprising a selection tool executable by the processor to detect the performer based at least in part on the information received from the engineer.

14. The system of claim 12, further comprising a selection tool executable by the processor to define the face associated with the performer based at least in part on the information received from the engineer.

15. The system of claim 12, further comprising a facial recognition application executable by the processor to define the face associated with the performer based at least in part on the information received from the engineer.

16. The system of claim 12, wherein the processor is further configured to execute instructions for generating a modified version of video clip, the modified video clip displaying portions of the script inserted at intervals designated by the engineer.

17. The system of claim 12, wherein the processor is further configured to execute instructions for detecting that a duplicate video clip already exists in memory and generating a notification regarding the duplicate video clip.

18. A computer-readable medium, having embodied thereon a program, the program being executable by a processor to perform a method for pre-engineering video clips for use in an interactive entertainment system, the method comprising:
receiving information from an engineer, the information regarding the detected performer;
detecting that a performer is present in a video clip;
defining a face associated with the performer detected as being present in the video clip;
designating a portion of the video clip for masking, the designated portion of the video clip corresponding to the defined face associated with the detected performer; and
storing the masking designation, the masking designation being stored in association with the information received from the engineer

19. The computer-readable medium of claim 18, wherein the program is further executable to define at least a part of a body associated with the performer, wherein the designated portion of the video clip further corresponds to the defined body part associated with the performer.

20. The computer-readable medium of claim 18, wherein the program is further executable to generate a modified version of video clip, the modified video clip displaying portions of the script inserted at intervals designated by the engineer.
